(19) United States
(12) Patent Application Publication
(10) Pub. No.: US 2002/0023023 A1
(43) Pub. Date: Feb. 21, 2002

(54) Methods and systems for network based electronic purchasing and shipping system

(76) Inventors: Dennis C. Borecki, Denville, NJ (US); Robert L. Chevlin, New Rochelle, NY (US); Peter N.R. van der Meer, New York, NY (US)

Correspondence Address: John S. Beulick, Armstrong Teasdale LLP, One Metropolitan Sq., Suite 2600, St. Louis, MO, 63102, US

(21) Appl. No.: 09/916,767

(22) Filed: Jul. 27, 2001

Related U.S. Application Data
(63) Continuation-in-part of application No. 09/865,253, filed on May 25, 2001.
(60) Provisional application No. 60/221,658, filed on Jul. 28, 2000.

(51) Int. Cl. G06F 17/60

(52) U.S. Cl. 705/26

(57) ABSTRACT

A method for facilitating private and secure shipping of packages using the Internet is disclosed which includes accessing a secure shipping system account, activating the account for shipping, setting a package delivery time limit, receiving temporary address codes that are assigned to the account, and using the temporary address codes to direct the shipping of the packages. Use of such a system ensures that purchases can be shipped to a consumer without ever having to reveal a final destination to a merchant.

### CROSS REFERENCE TO RELATED APPLICATIONS

This application is a Continuation-in-Part of U.S. patent application Ser. No. 09/865,253, filed May 25, 2001, and further claims the benefit of U.S. Provisional Application No. 60/221,658, filed Jul. 28, 2000, which is hereby incorporated by reference in its entirety.

### BACKGROUND OF THE INVENTION

This invention relates generally to computerized information management and processing systems, and more specifically to a system and method that facilitates a secure environment for the electronic purchasing of goods and services and shipping of goods via the Internet.

When a consumer connects to the Internet to purchase goods and services from a virtual merchant web site, the customer is commonly required to complete one or more forms which asks for personal as well as credit card payment information and shipping information. The information entered into these forms often includes such items as credit card number, type of credit card, expiration date of credit card, consumer name, address, city, state, zip-code, home telephone number, and often business telephone number. Any or all of these items may be considered by the consumer to be confidential in nature. As a result, consumers most often abandon their on-line purchases at the point of checkout, unwilling to pass their personal information through the Internet.

### BRIEF SUMMARY OF THE INVENTION

In one aspect of the present invention, a method for facilitating private and secure shipping of packages using the Internet is provided which comprises accessing a secure shipping system account, activating the account for shipping, setting a package delivery time limit, receiving temporary address codes that are assigned to the account, and using the temporary address codes to direct the shipping of the packages.

In another aspect, a system is provided which is configured to facilitate private and secure shipping for a user via the Internet. The provided system comprises a central computer further comprising a private shipping module, a mail and shipping carrier database module, and a temporary address codes module. The system further comprises at least one Internet server coupled to the central computer and at least one of an additional Internet and an intranet server coupled to said central computer. The system is further coupled, via intranet or Internet, to a computer for a mail/shipping carrier. The central computer is also configured to assign temporary shipping address codes using a temporary address codes module, to an account of a registered user, the temporary shipping address codes being sent by the system to the carrier computer, via the Internet, as shipping instructions for the package or packages.

In still another aspect, a method for operating a computer to facilitate private and secure shipping is provided. The method comprises prompting a user to enter a user ID and a password, prompting the user to activate private shipping; retrieving user account information, and generating at least one temporary shipping address code for use by the user for shipping one or more packages.

In yet another aspect, a database is provided which comprises data corresponding to merchants who are partnered with a private and secure shipping system provider, data corresponding to temporary shipping address codes, data corresponding to user accounts, data corresponding to customer histories, and data corresponding to user IDs and passwords.

In a further aspect, a system to facilitate secure purchasing and shipping via the Internet is provided which comprises a central computer that further comprises a digital checkbook module, a merchant database module, a temporary card number module, a private shipping module, a mail and shipping carrier database module, and a temporary address codes module. The system further comprises at least one Internet server coupled to said central computer; and at least one of an additional Internet and an intranet server coupled to the central computer, allowing the central computer to couple to an acquiring bank processor and a computer for a mail/shipping carrier. The central computer is configured to assign temporary debit and credit card numbers using a temporary card number module, to a checkbook of a registered user, the checkbook located within the digital checkbook module, the temporary card numbers being sent by the system to a merchant, via the Internet, to pay for purchases made by the registered user when accessing a merchant website. The central computer is further configured to assign temporary shipping address codes using the temporary address codes module, to an account of a registered user, the temporary shipping address codes being sent by said system to the carrier computer, via the Internet, as shipping instructions for the package or packages.

### BRIEF DESCRIPTION OF THE DRAWINGS

FIG. 1 is a functional block diagram of a private and secure Internet purchasing system.

FIG. 2A is a functional flow diagram showing the overall method of operation of the system shown in FIG. 1.

FIG. 2B is a functional flow diagram of the initial user sign-up process.

FIG. 2C is a functional flow diagram of the user sign-on process.

FIG. 2D is a functional flow diagram of the user account retrieval process.

FIG. 2E is a functional flow diagram of the user opening their digital checkbook.

FIG. 2F is a functional flow diagram of the purchasing process.

FIG. 3 is an example of a user login page.

FIG. 4 is an example of a user sign-up page.

FIG. 5 is an example of a shopping tool bar.

FIG. 6 is an example of a user help page for the online checkbook.

FIG. 7 is an example of a shopping search page.

FIG. 8 is an example of a shopping search results page.

FIG. 9 is an example of a user pre-authorization page.

FIG. 10 is an example of an authorization page.

FIG. 11 is an example of a select items to return page.

FIG. 12 is an example of a returns confirmation page.

FIG. 13 is an example of a transaction history page.

FIG. 14 is an example of a shipping options page.

FIG. 15 is an example of an add recipient page.

FIG. 16 is a functional block diagram of the system of FIG. 1, further incorporating private and secure Internet shipping within the system.

FIG. 17 is a functional flow diagram of the initial user sign-up process for private and secure shipping.

FIG. 18A is a functional flow diagram showing the overall method of operation for private and secure shipping.

FIG. 18B is a functional flow diagram of a temporary shipping address assignment process.

FIG. 18C is a functional flow diagram of a shipping process of purchases from a merchant.

### DETAILED DESCRIPTION OF THE INVENTION

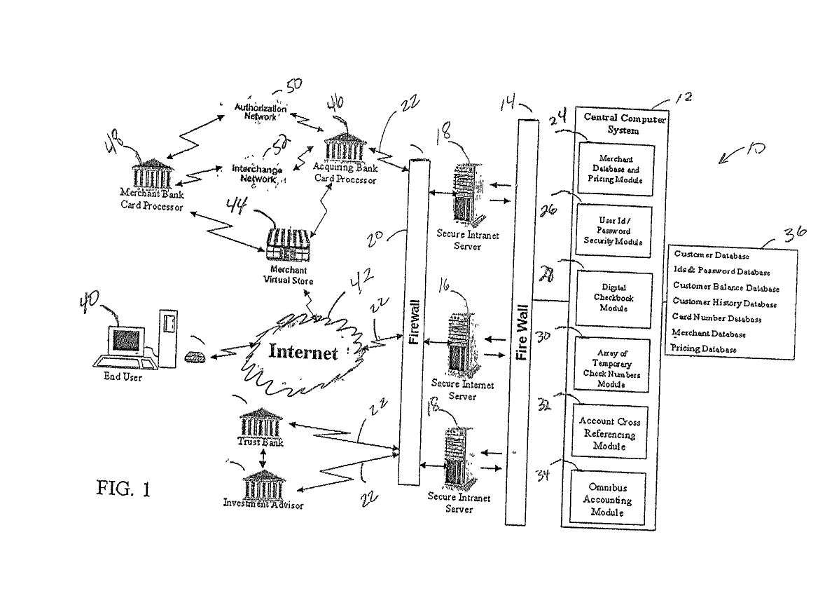

FIG. 1 is one embodiment of an Internet based system 10 according to the present invention. Referring specifically to FIG. 1, system 10 includes a central computer system 12, connected through a firewall 14 to at least one Internet server 16 and at least one intranet server 18. Internet servers 16 and intranet servers 18 are connected to a second firewall 20 which provides communications interface 22 with outside entities. Central computer system 12 receives input signals and transmits output signals over various communications channels and also includes the capability to communicate bi-directionally with other computers as well as the capability to access databases as further described below. Telephone lines and the Internet are used as the primary communications links

Central computer system 12 includes a plurality of modules and databases for providing private and secure purchasing for registered users via the Internet. In one embodiment, in central computer system 12 includes a merchant database and pricing module 24, a user ID/password security module 26, a digital checkbook module 28, a temporary card numbers module 30, an account cross-referencing module 32 and an omnibus accounting module 34. Further included within central computer system 12 is a database unit 36 which includes a plurality of databases, described below and including, in the embodiment shown, a customer database, an IDs and passwords database, a customer balance database, a customer history database, a card number database, a merchant database, and a pricing database. In other embodiments, database 36 is located external to central computer system 12.

As stated above, central computer system 12 is configured to provide private and secure purchasing for registered users. A person using a user computer 40 connects to the Internet 42 through any of a variety of known methods and connects to a web site hosted on Internet server 16 and proceeds to register to become a registered user and to set up user accounts and balances. Once a registered user, the person is able to access their account to make purchases, for example, from a merchant web site hosted on merchant computer 44, via Internet 42.

A merchant is either partnered with the private and secure purchasing provider, or they or not. For merchants partnered with the private and secure purchasing provider, transactions for Internet purchases are treated as debit card transactions by an acquiring bank card processor 46 which is connected through a network, intranet or Internet, to merchant computer 44 and central computer system 12. For merchants not partnered with the private and secure purchasing provider, transactions for Internet purchases are treated as credit card transactions. For such merchants, merchant computer 44 is configured to relay information regarding the transaction to a merchant bank card processor 48, which relays the transaction information, via an authorization network 50 to acquiring bank card processor 46 which is connected to central computer 12 through a secure network. After verification of sufficient account finding, acquiring bank card processor 46 transmits an approval or denial over authorization network 50 and funds are transferred from acquiring bank card processor 46 to merchant bank card processor 48 via an interchange network 52. By partnering with the private and secure purchasing provider, merchants and financial institutions, for example, acquiring bank card processor 46, are able to access and provide per-transaction debit card pricing for the service, rather than credit card pricing.

In one embodiment, member merchants have a button on their website which allows processing of purchases using a customized form. The form is populated by accessing the identification output file placed on the user computer 40 by central computer system 12 and filling the fields with the necessary purchasing information including the users temporary debit card number. The process allows the merchant to access special per-transaction debit card pricing rather than credit card pricing as described above.

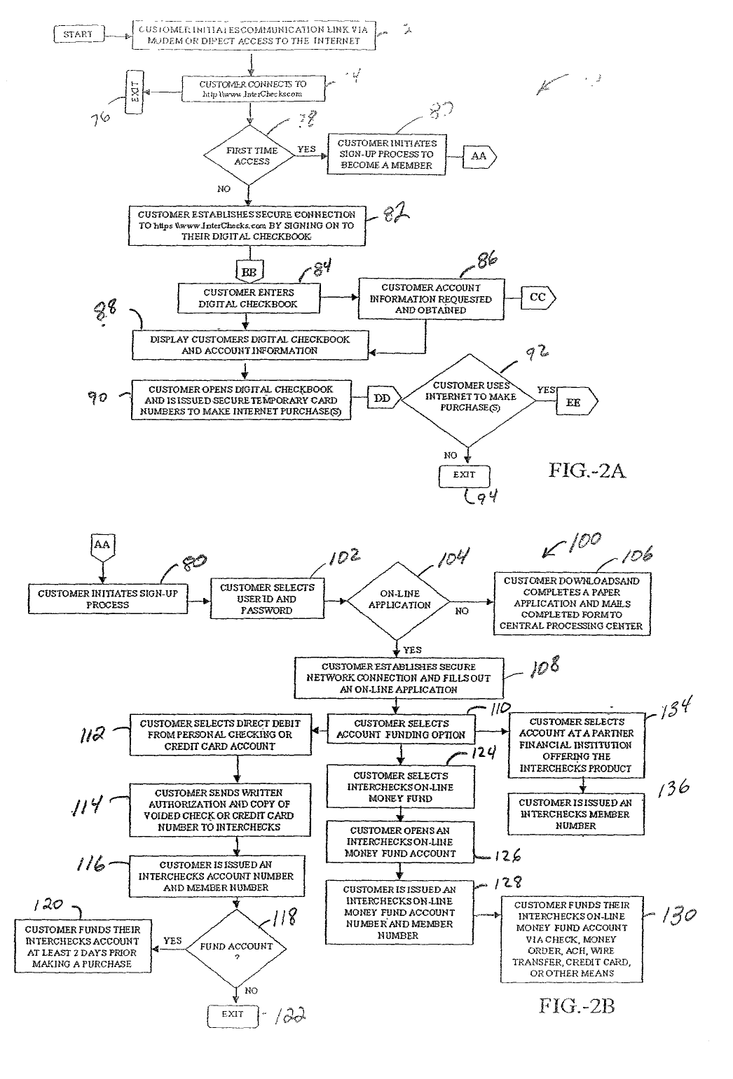

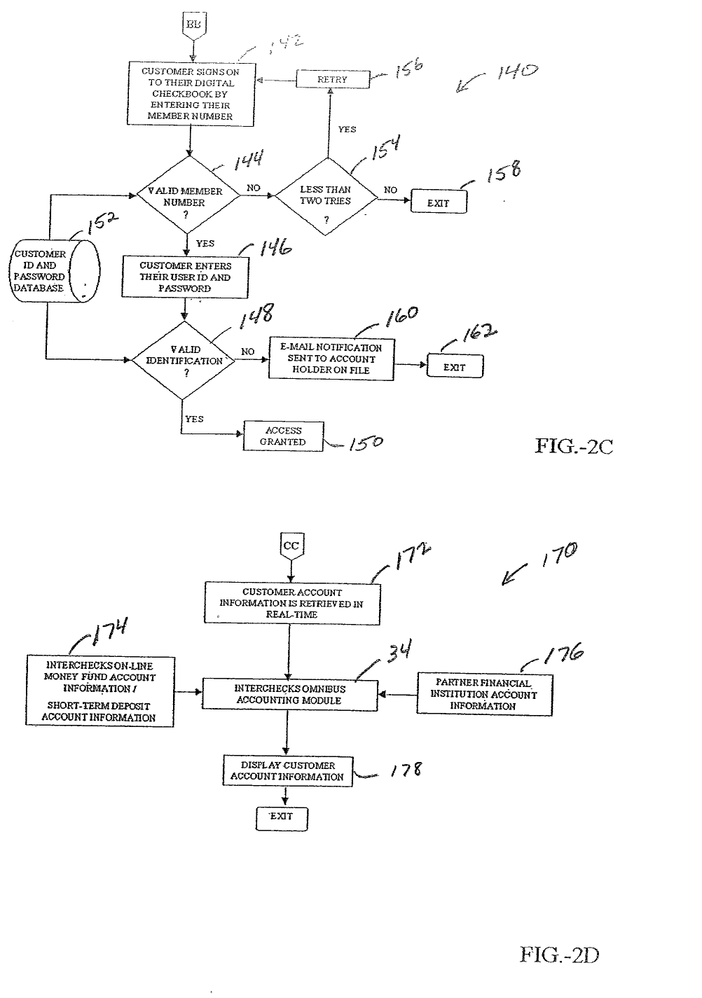

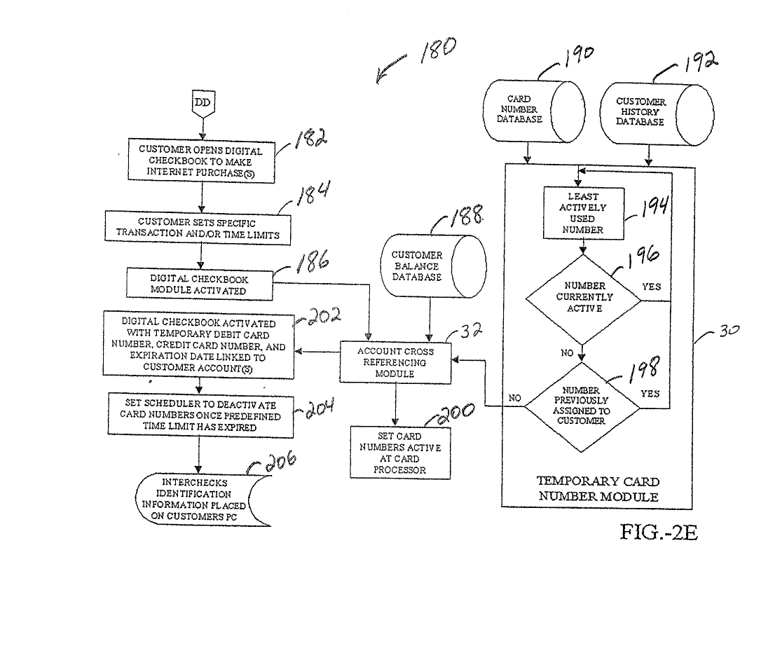

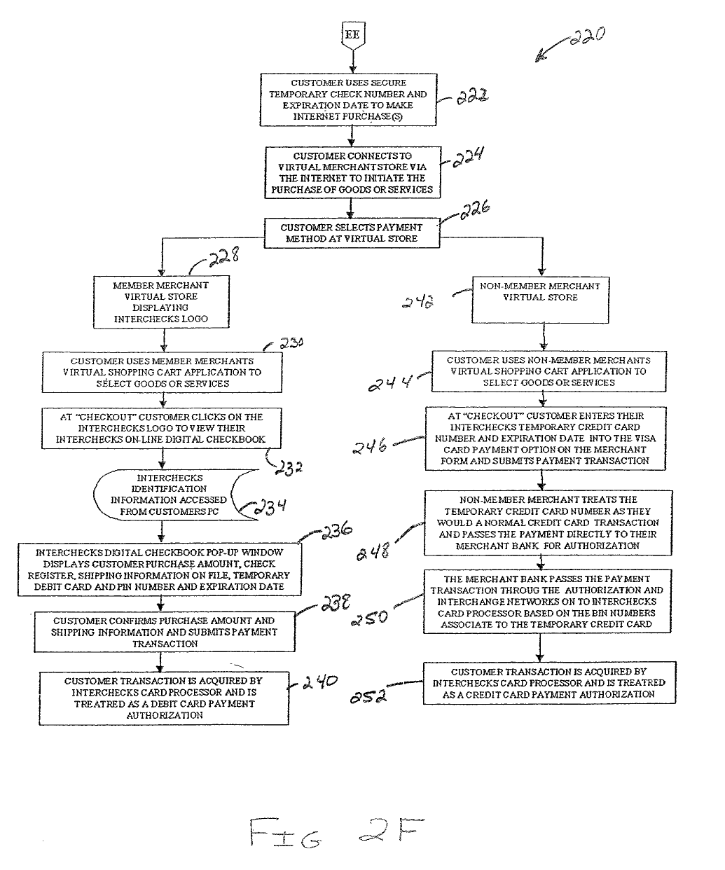

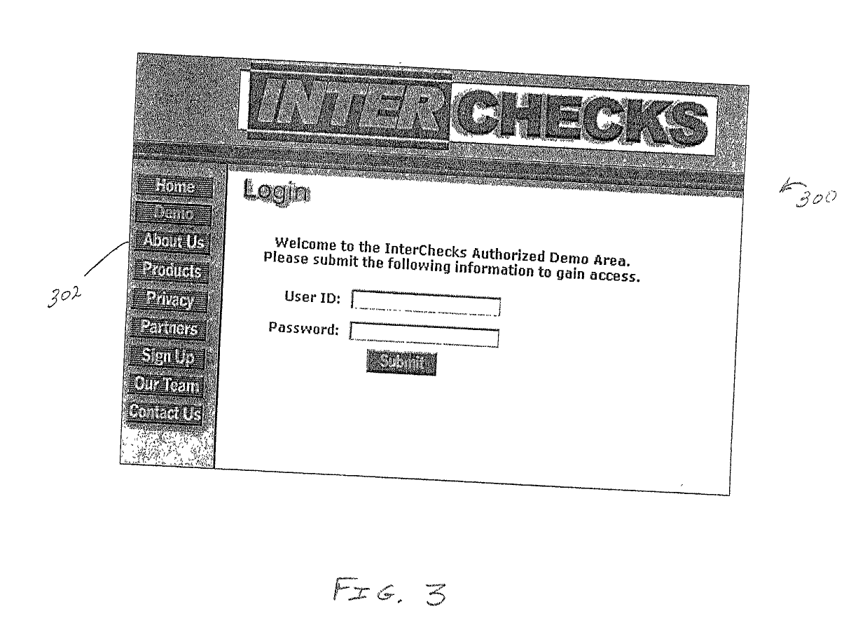

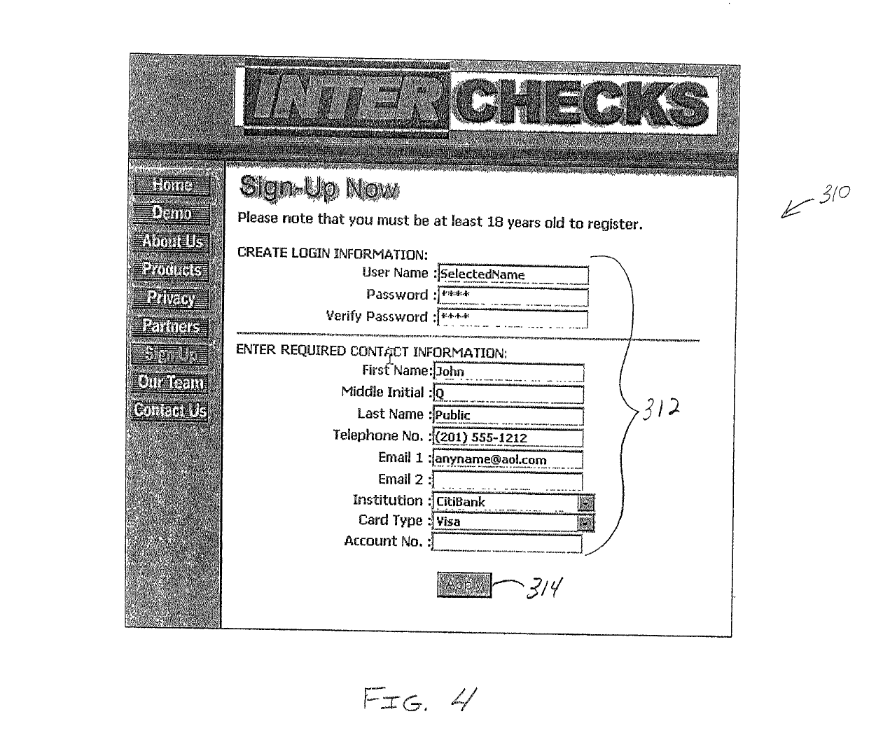

FIG. 2A is a flowchart 70 which diagrams procedures executed by and implemented in central computer system 12 of system 10 (shown in FIG. 1). After a user initiates 72 Internet access, they choose to connect 74 to the private and secure purchases provider web site. The user may choose to exit 76 at this time. Alternatively, if the user chooses to continue, they are queried 78 if they are accessing central computer system 12 for the first time. If the user is accessing for the first time, a sign up process is initiated 80 which is described in further detail in FIG. 2B below. If not accessing for the first time, the user establishes 82 a secure connection to the private and secure purchases provider web site, and enters 84 their digital checkbook, which is described in further detail in FIG. 2C below.

The user then chooses whether to request and obtain 86 account information or to display 88 their checkbook with account information. After account information is requested and obtained 86, the checkbook with account information is displayed 88. After display 88 of checkbook with account information, the user opens the checkbook and is issued 90 secure temporary card numbers, both debit and credit, for Internet purchases, which are described in further detail in FIG. 2E below. After temporary card numbers are issued 90, the user chooses 92 whether or not to make purchases via the Internet. The user exits 94 if no purchasing is to be done at this time. Internet purchasing is further described in FIG. 2F below.

FIG. 2B is a flowchart 100 which shows steps followed when a user initiates 80 (also shown in FIG. 2A) a sign up process. First, the user selects 102 a user ID and a password, and then selects 104 whether an application will be completed online or off line. If off line, the user downloads 106 a paper application and mails the completed application to a central processing center (not shown). If the application is to be completed online, the user establishes 108 a secure network connection and completes an online application. In completing the application, online or off line, the user selects 110 an account funding option. Two funding options are a selection 112 of a direct debit from a personal checking account or selection 112 of a charge to a credit card account. Upon such a selection 112, the user sends 114 a written authorization and a copy of a voided check or a credit card number to the private and secure purchasing system provider. After processing is completed, the user is issued 116 a secure purchasing provider account number and member number. If the user chooses to fund 118 their account at this time, they fund 120 their private and secure account, otherwise the user exits 122 the web site.

The user may select 124 a private and secure purchasing provider online money fund as their preferred method of funding their account for Internet purchases. To fund an account for Internet purchases in this manner, the user opens 126 a private and secure purchasing provider online money fund account. After opening 126 the account, the user is issued 128 a private and secure purchasing provider online money fund account number. To fund 130 the online money fund account, the user provides the private and secure purchasing provider funds via one of check, money order, ACH, wire transfer and credit card, for example. Of course, other funding vehicles may be used to fund the account. After funding the online money fund account, the user exits 132.

A further method for funding a user account is by selecting 134 to have an account at a financial institution that has partnered with the private and secure purchasing provider to provide purchasing accounts, for example, acquiring bank card processor 46 (shown in FIG. 1). When the account is opened at the financial institution, the user is issued 136 a private and secure purchasing provider member number.

FIG. 2C is a flowchart 140 which further illustrates of a process where a user signs on and activates their digital checkbook. A user signs on by entering 142 their private and secure purchasing provider member number. If the entered membership number is valid 144, the user is instructed to enter 146 their user ID and password. If the user ID is valid 148, access is granted 150. User IDs and membership numbers are provided in a database 152, which is part of database 36 (shown in FIG. 1). If an invalid member number is entered, and the number of attempts to enter the digital checkbook is below 154 a threshold, the user may retry 156 entering the digital checkbook, otherwise central computer system 12 (shown in FIG. 1), disconnects the user, forcing an exit 158. If a membership number entered 142 is valid 144, but the user ID entered 146 is not valid 148, an E-mail notification is sent 160 to the account holder of record, and central computer system 12 exits 162.

FIG. 2D is a flowchart 170 which illustrates a process for account information retrieval. First, after entering 84 (shown in FIG. 2A) the digital checkbook, user account information is retrieved 172 in real time and copied to omnibus accounting module 34 (also shown in FIG. 1). Depending on the funding option previously selected, money fund account information and short-term deposit account information 174 and/or partner financial institution account information 176 are copied to accounting module 34. Omnibus accounting module 34 then causes central computer system 12 to display 178 user account information.

FIG. 2E is a flowchart 180 illustrating opening and activation of the digital checkbook for making Internet purchases. A user which has successfully entered the private and secure purchasing provider system by entering a valid member number and user ID/password, opens 182 their digital checkbook, which is a register of the member's account, to make Internet purchases. The user then sets 184 at least one of specific transaction limits or time limits on the purchasing session. The digital checkbook module 28 (shown in FIG. 1) is then activated 186. Notification of the activation is sent to account cross referencing module 32 (also shown in FIG. 1). Further, a customer account balance is sent to account cross referencing module 32 from a customer account database 188 within database 36 (shown in FIG. 1). Also sent to account cross referencing module 32 is a temporary card number used for making the purchases. The temporary account number is generated based on information within card number database 190 and customer history database 192, both within database 36. Temporary card number module 30 (also shown in FIG. 1) determines 194 a least active card number within database 190 and determines 196 if the number is currently active. If active, module 30 determines another card number that has been inactive the longest amount of time. The process is repeated until a card number that is currently inactive is identified. Once a inactive card number is determined 196, module 30 determines 198 if the particular card number has ever been assigned to that user in a previous purchasing session. If so, the process above is repeated until an inactive card number that has never been assigned to the particular user is identified. The temporary card number is then sent to account cross referencing module 32, which activates 200 the temporary card numbers by sending instructions to a card processor, for example, acquiring bank card processor 46 (shown in FIG. 1) to activate the card numbers.

The digital checkbook is then activated 202 with a temporary debit card number, a temporary credit card number, and an expiration date all of which are linked to the user account. A scheduler is then set 204 to deactivate the card numbers, debit and credit, once one of a pre-defined time limit has expired or a transaction amount limit has been exceeded. User account information, for example, account balance and card numbers, is placed 206 on user computer 40 (shown in FIG. 1) in the form of an identification output file, from central computer system 12 (shown in FIG. 1).

FIG. 2F is a flowchart 220 illustrating using 222 the temporary card numbers and expiration dates of the card numbers to make Internet purchases. Referring specifically to flowchart 220, the user connects 224 to merchant computer 44 (shown in FIG. 1) to shop and make selections for purchase via the Internet. After making their selections, the user selects 226 a payment method, depending on whether the merchant is partnered with the private and secure purchasing provider. If so partnered, the virtual store displays 228 a logo of the private and secure purchasing provider. The user then uses 230 a member merchant's virtual shopping cart application to select goods and services. When ready to “check out” the user selects 232 the logo of the private and secure purchasing provider to view their online digital checkbook. Information from the identification output file is then uploaded 234 from user computer 40 (shown in FIG. 1) to merchant computer 44. A digital checkbook pop-up window is displayed 236 which includes a user purchase amount, a check register, shipping information that is on file, a temporary debit card and pin number, and expiration date. The user then confirms 238 the purchase amount and shipping information and submits a payment transaction. The user transaction is acquired 240 by a private and secure purchasing provider processor and is treated as a debit card payment authorization.

If the merchant is not partnered with the private and secure purchasing provider, shopping at the non-member merchant virtual store 242 is as follows. The user then uses 244 a member merchant's virtual shopping cart application to select goods and services. When ready to “check out” the user enters 246 their private and secure purchasing provider temporary credit card number and expiration date into the credit card payment option on the merchant's payment form and submits the payments transaction. The non-member merchant treats the temporary credit card number as a normal credit card transaction and passes 248 the payment directly to their merchant bank for authorization.

The merchant bank passes 250 the payment transaction through authorization and interchange networks onto the private and secure purchasing provider based on BIN numbers associated with the temporary credit card. The user transaction is acquired 252 by a private and secure purchasing provider processor and is treated as a credit card payment authorization.

Operation of such a private and secure purchasing system as described above is further described using exemplary displays which are displayed by central computer system 12 at user computer 40 and described below.

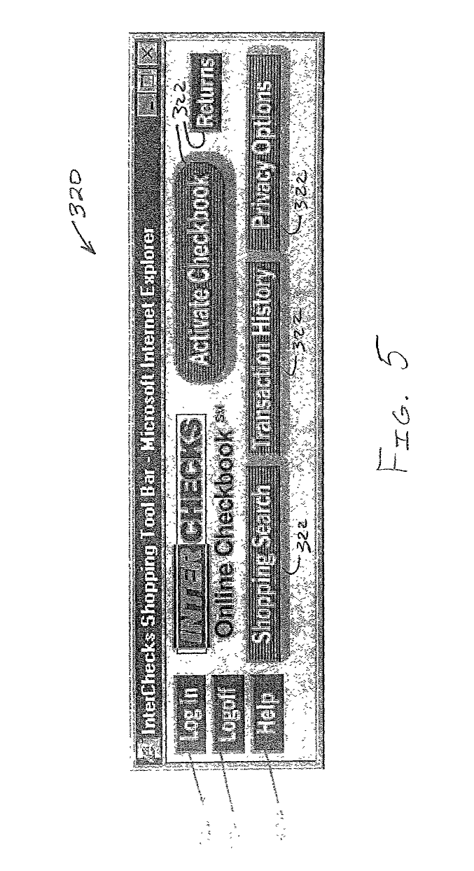

FIG. 3 is an embodiment of a user login screen 300. Screen 300 is displayed on user computer 40 (shown in FIG. 1) when a person accesses central computer system 12 via Internet 42 and through Internet server 16. Persons who are registered users may simply enter and submit their pre-selected username and password to begin private and secure Internet shopping. If not a registered user, the person who has accessed login screen 300, may select a sign up button in selection bar 302 to register, as described below.

FIG. 4 is an exemplary embodiment of a user registration page 310, which is displayed upon selection of the sign up button on page 300 (shown in FIG. 3). Page 310 includes data entry fields 312 where a user wishing to register enters such items as a selected usemame and password, personal identification data, email addresses and account data, to which their future secure purchases will actually be charged against, for example, a bank checking or savings account or a personal credit card. In one embodiment, a registered user will pre-fund a deposit account for their future purchases. Selecting an apply button 314, uploads the user entered information to central computer system 12 for new account processing.

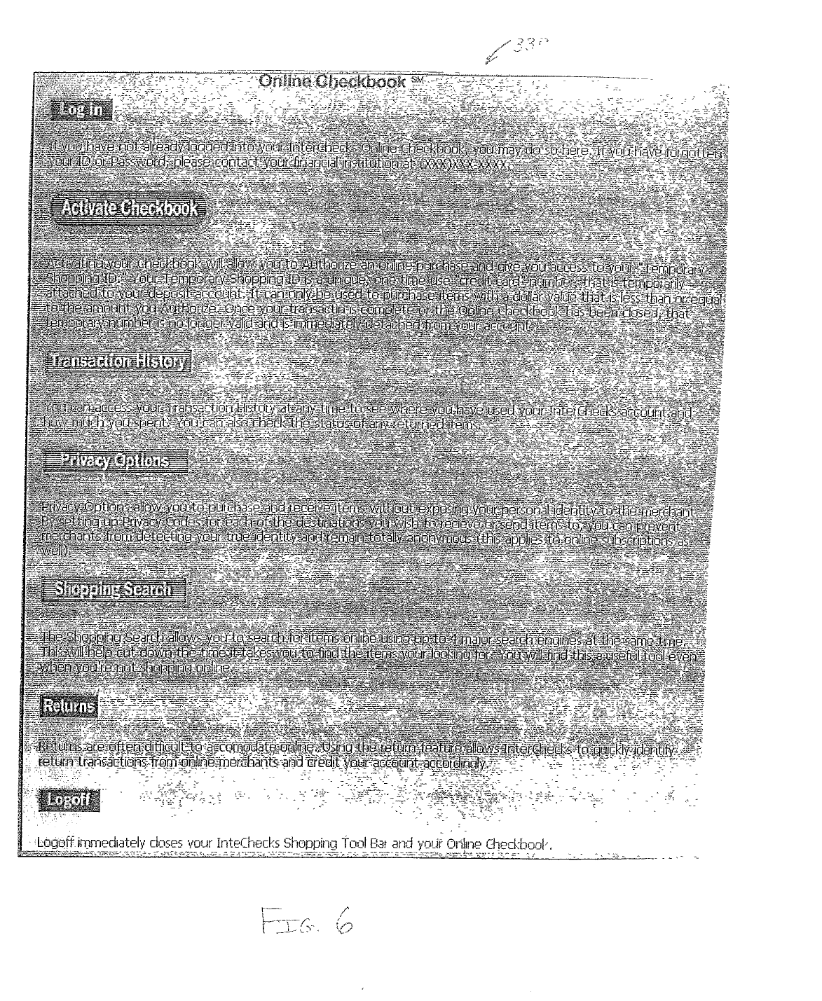

FIG. 5 is an exemplary embodiment of a start page 320, which is displayed to a user upon a successful login. Page 320 provides the registered user with choices such as activating their digital checkbook, performing a search, viewing a transaction history, setting privacy options, and performing returns, all described below. In one embodiment of start page 320, the user choices are configured as selectable icons 322.

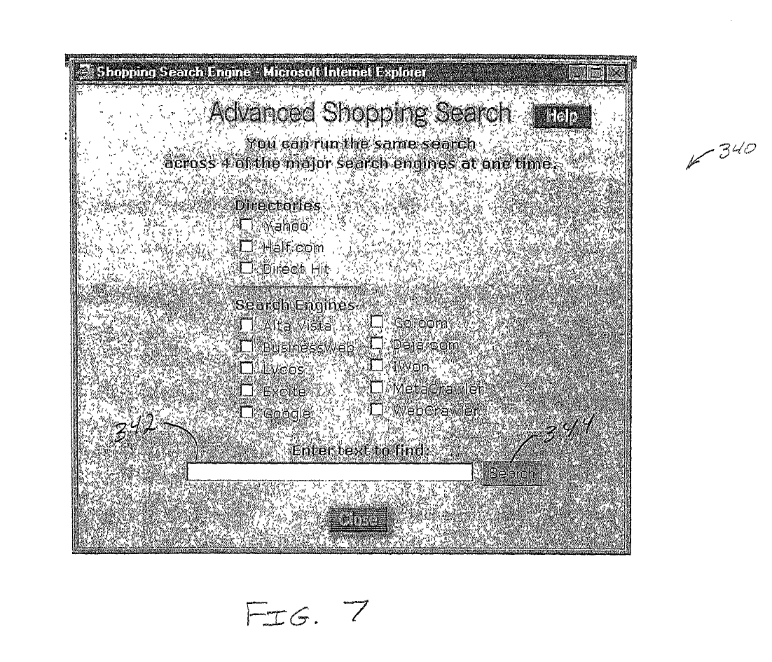

FIG. 6 is a help page 330 which displayed upon selection of a help option within start page 320 (shown in FIG. 5). Page 330, in the embodiment shown, includes descriptions for logging in and logging off, activating the digital checkbook, viewing transaction histories, privacy options, the shopping search and returns. In addition, the descriptions are headed by selectable icons 322 (also shown in FIG. 5) which, when selected, activate the particular function, for example, a transaction history.

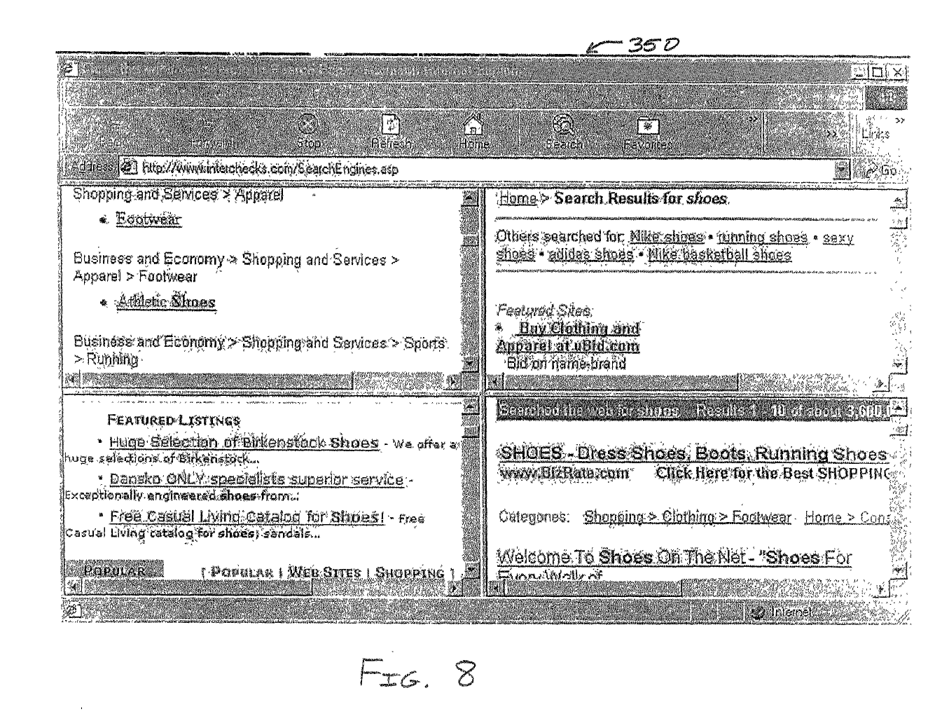

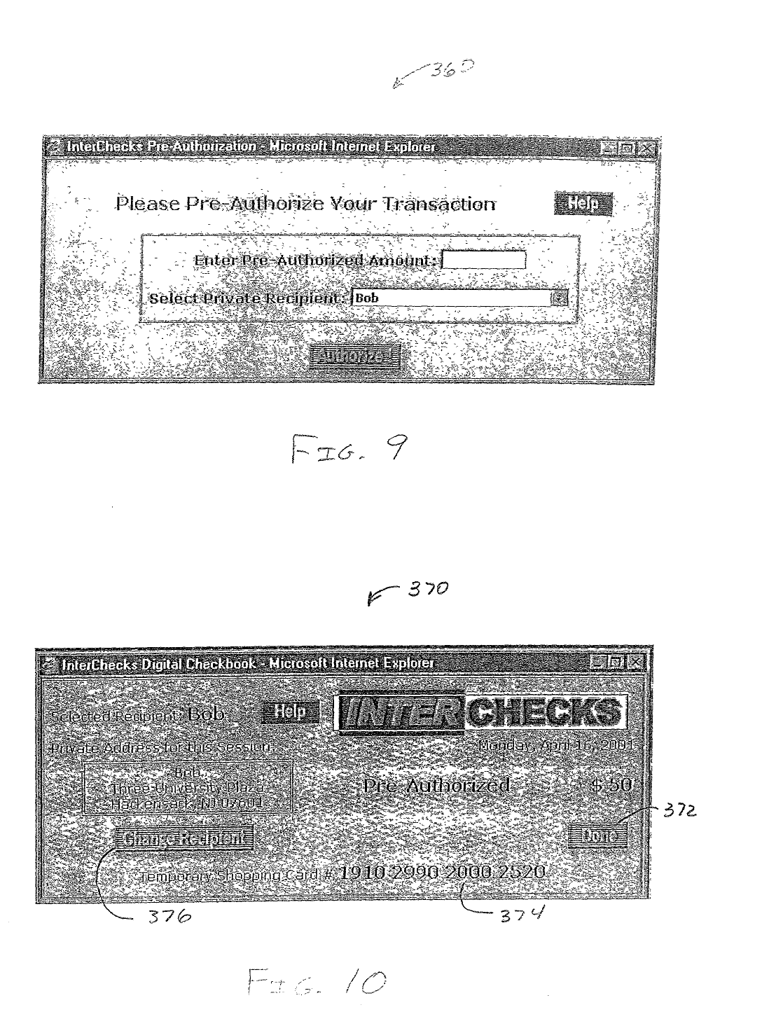

FIG. 7 is an exemplary embodiment of a shopping search page 340. Search page 340 allows a user to search for their desired purchase using one or more of the popular search engines and directories available on the Internet. To perform the search the user selects which of the search engines and directories they wish to use, then a purchase item, for example, “shoes” is entered into a text box 342, and a search is initiated by selection of a search button 344 and displayed on a search results page 350, as shown in FIG. 8, which is displayed upon completion of the search as entered into shopping search page 340. It is to be noted that selection of search button 344 initiates searches on all of the selected search engines and directories, and that the item to be searched for, “shoes”, for example, is entered by the user only once for search results for all of the search engines and directories.

Referring specifically to FIG. 8, search results for a plurality of the well-known search engines and directories are displayed on a multiple frame, search results page 350. Search results within each frame are displayed and hyperlinks within the frames are selectable. Selection of a hyperlink within a frame causes a browser window to open and display the selected hyperlink.

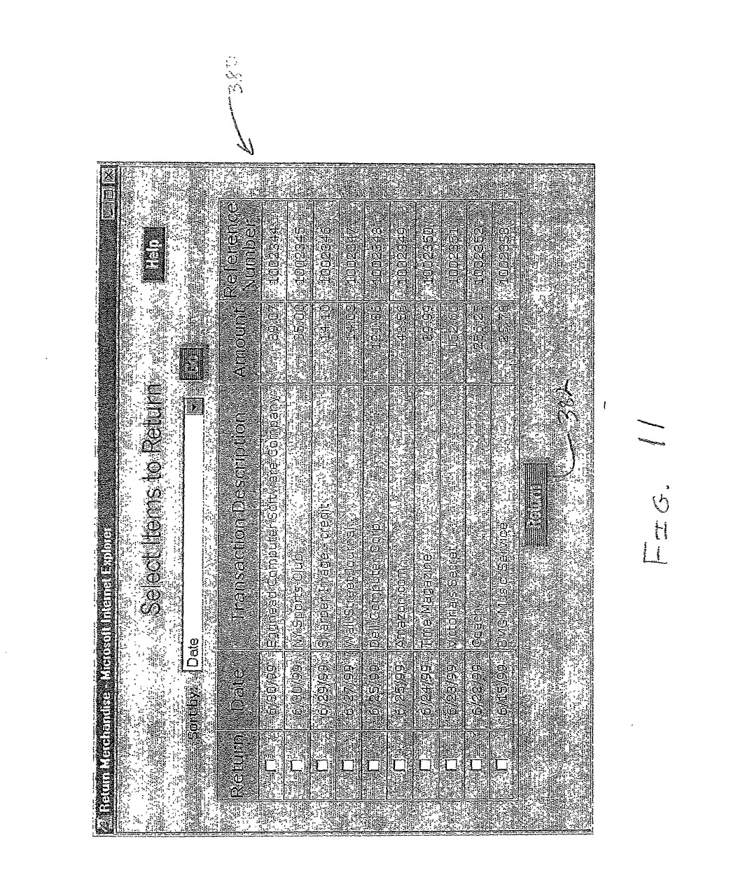

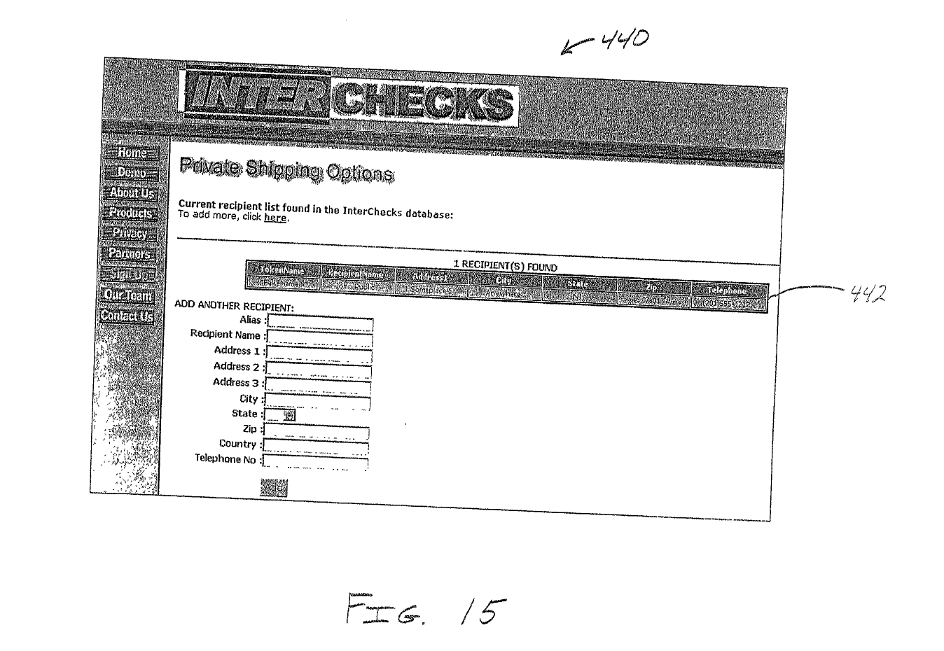

FIG. 9 is an exemplary embodiment of a pre-authorization transaction page 360 which is displayed upon selection of an item for purchase from shopping results page (not shown). To pre-authorize a transaction, the registered user enters an amount to be authorized, and further enters a recipient of the authorized amount. The transaction is not authorized until the user selects an authorize button 362. In addition, a registered user is able to select a recipient which is another person or which may be an alias for the registered user as described in FIG. 14 below.

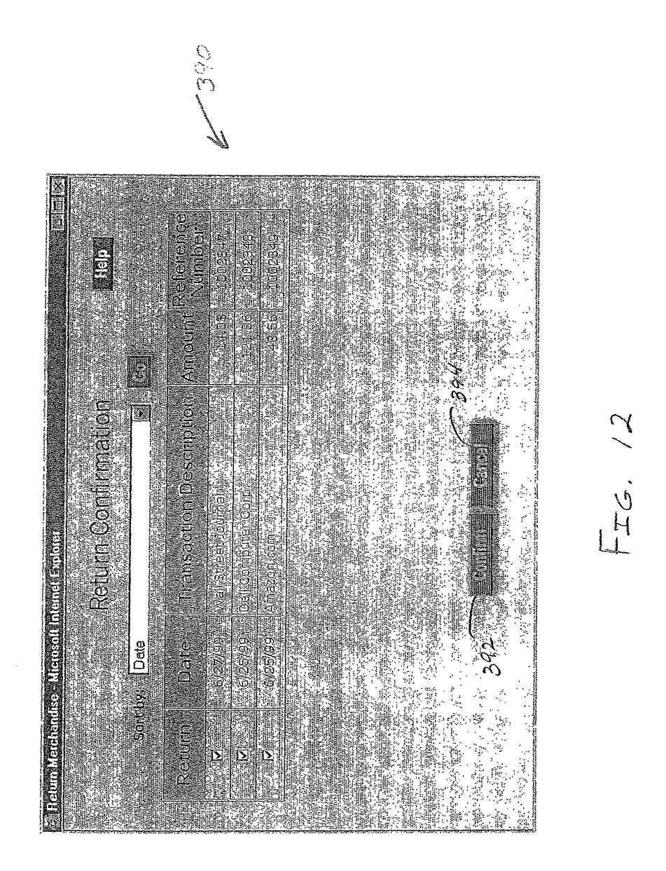

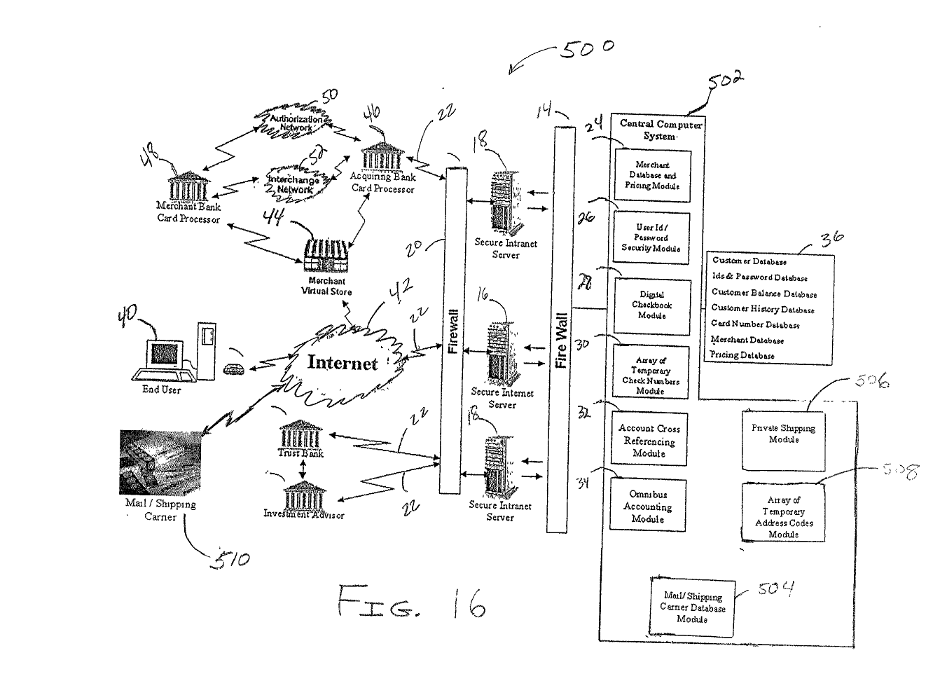

FIG. 10 is an exemplary embodiment of an authorization page 370 for the transaction. The transaction, and therefore the purchase, is not completed until the user checks the information within authorization page 370 for correctness and completeness. Selection of a done button 372, authorizes the purchase, and further causes the merchant to be notified of the purchase, in the form of a transmission to merchant computer 44 (shown in FIG. 1). Notification of the purchase includes presenting the merchant with payment for the items purchased, that is, sending temporarily valid card number 374 to merchant computer 44, which causes card number 374 to be processed through card processors 46 and 48 as described above. Selection of done button 372 further causes the user's deposit account to be reduced by the purchase amount. If upon review of page 370, the user wishes to change a previously selected recipient, a change recipient button 376, causes, upon selection, an availability to the user for a change of recipient. Entry of recipient information for storage in central computer system 12 (shown in FIG. 1) is described in FIGS. 14 and 15 below.

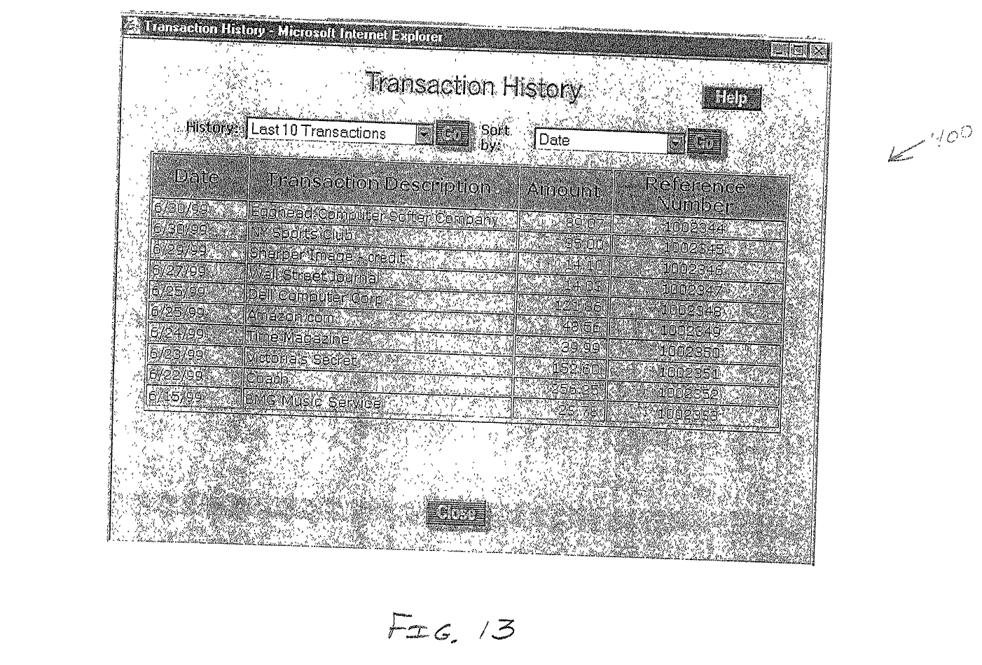

FIG. 11 is an exemplary embodiment of a returns page 380. Upon selection of the returns option on page 320 (shown in FIG. 5), central computer system 12 (shown in FIG. 1) causes returns page 380 to be displayed. Page 380 includes dates, descriptions, amounts, and reference numbers for recent transactions. Transactions are further sortable by any one of date, reference number, amount and description of transaction. A user is able to select any one or a number of transactions for return by selection of a return checkbox for each transaction. Selection of a return button 382 causes a return confirmation page to be displayed.

FIG. 12 is an exemplary embodiment of a return confirmation page 390. Page 390 displays all of the items selected for return, in the same format, as page 380 (shown in FIG. 11). Selection of a confirm button 392 causes central computer system 12 to notify the merchants of the return and further enters a credit to the user's deposit account. A cancel button 394 causes a cancellation of the contemplated returns. As described for page 380, page 390 allows a user to sort items marked for return by any of date, description, amount and reference number.

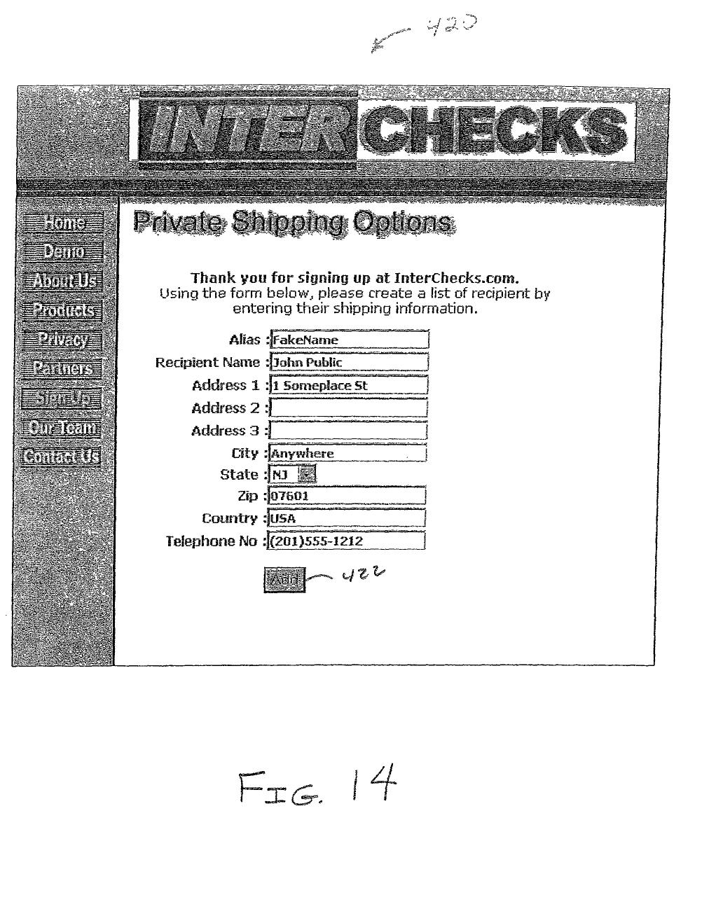

FIG. 13 is an exemplary embodiment of a transaction history page 400. Upon selection of the transactions history option on page 320 (shown in FIG. 5), central computer system 12 (shown in FIG. 1) causes returns page 380 to be displayed. Page 400 includes dates, descriptions, amounts, and reference numbers for transactions. Transactions displayed on page 400 are further sortable by any one of date, reference number, amount and description of transaction, as selected by the user. A length of the transaction history displayed is further selectable by the user. As shown on page 400, the history displayed is the last 10 transactions. Smaller or larger numbers of transactions can be selected by the user.

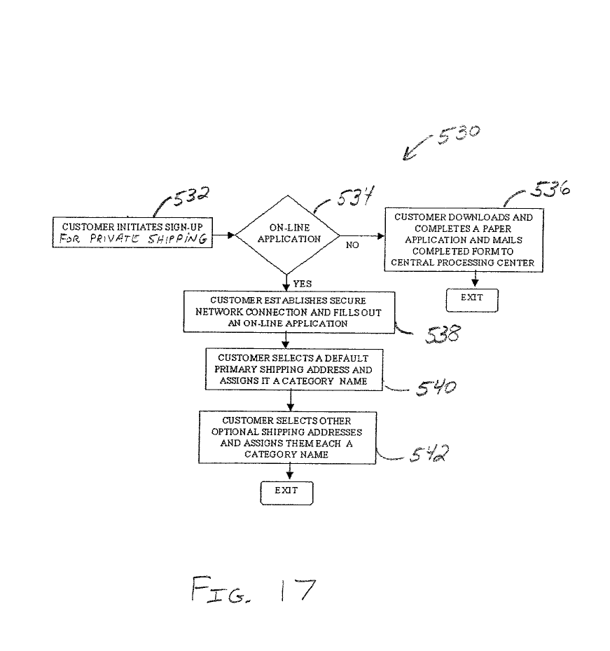

FIG. 14 is an exemplary embodiment of a private shipping options page 420. Shipping options page 420 allows a registered user to enter shipping information, for example, name, address and telephone number for storage in database 36 of central computer system 12 (both shown in FIG. 1) for recipients of a registered user's online purchases. In addition, shipping options page 420 allows a user to enter an alias for each recipient. The alias is supplied to merchants when purchasing items from a merchant's virtual store. In addition to allowing a user of the private and secure purchasing system anonymity when shopping, using aliases allows a user to purchase gifts for others, whose aliases and shipping information the user has previously stored within database 36, without providing the other's names and addresses to the merchants. Private and secure shipping processes are further described in FIGS. 16-18C below.

Aliases are stored within database 36 after entry of the shipping information and selection of an Add button 422. Referring to FIGS. 9 and 10, a user is able to select from their listing of stored aliases when pre-authorizing a transaction, by selecting a private recipient, or after authorization using change recipient button 376. Selected aliases are part of the identification output file (described above) which is transferred from central computer system 12 to user computer 40 and sent to merchant computer 44 (all shown in FIG. 1) when the user makes a purchase from the merchant.

FIG. 15 is an exemplary embodiment of an add recipient page 440, where the registered user is able to view a current recipient list 442, including aliases, and can add additional recipients including aliases, in the same manner as recipients are added on shipping options page 420 (shown in FIG. 14).

FIG. 16 is one embodiment of an Internet based system 500, similar to system 10 (shown in FIG. 1), and which further includes modules which incorporate a private and secure shipping function. Components in system 500, identical to components of system 10 (shown in FIG. 1), are identified in FIG. 16 using the same reference numerals. Referring specifically to FIG. 16, system 500 includes a central computer system 502, connected through a firewall 14 to at least one Internet server 16 and at least one intranet server 18, as described above.

Central computer system 502 is configured with a plurality of modules and databases for providing private and secure purchasing and shipping of goods for registered users via the Internet. In one embodiment, central computer system 502 includes, in addition to the modules described above in system 10, a mail/shipping carrier database module 504, a private shipping module 506, and an array of temporary address codes module 508.

As stated above, central computer system 502 is configured to provide both private and secure purchasing and private and secure shipping of purchases for registered users. A person using a user computer 40 connects to the Internet 42 through any of a variety of known methods and connects to a web site hosted on Internet server 16 and proceeds to register to become a registered user and to set up user accounts, balances and shipping addresses, that is, final destinations. Once a registered user, the person is able to access their account to make purchases and direct the shipping of a product, for example, from a merchant web site hosted on merchant computer 44 and from a web site of a mail/shipping carrier 510, via Internet 42.

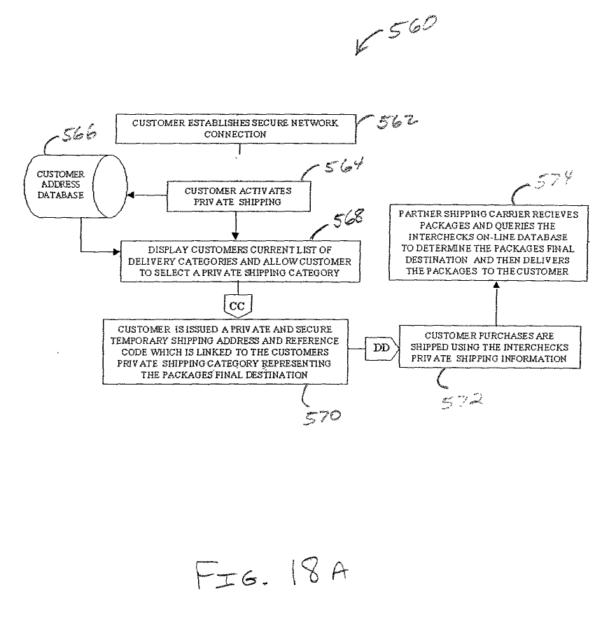

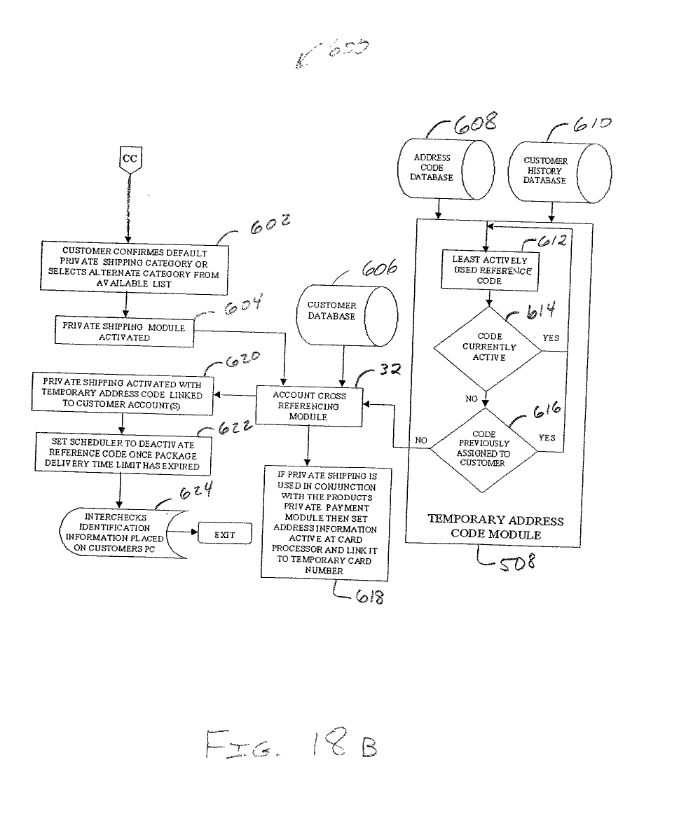

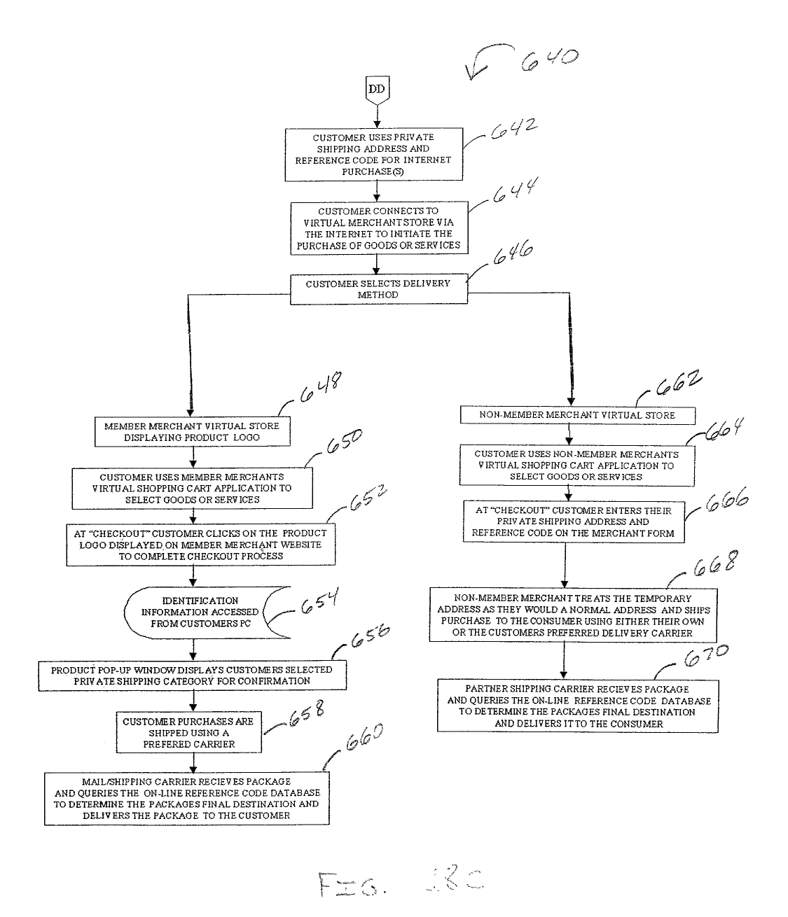

It should be noted that the processes for private and secure shipping described herein in FIGS. 17, 18A, 18B and 18C below, can be implemented separately, as described herein. In addition, these processes can be implemented in parallel with the processes for private and secure purchasing described above in FIGS. 2A-2F.

FIG. 17 is a flowchart 530 which shows steps followed when a user initiates 532 a sign up process for private and secure shipping. First, the user is queried 534 whether an application will be completed online or off line. If off line, the user downloads 536 a paper application and mails the completed application to a central processing center (not shown). If the application is to be completed online, the user establishes 538 a secure network connection and completes an online application. In completing the application, online or off line, the user selects 540 a default primary shipping address and assigns that address a category name, or alias, through a user interface, for example, shipping options page 420 (shown in FIG. 14). Further, the customer has an option of entering 542 and storing other optional shipping addresses and assigning each of those addresses a category name (alias) through another user interface, for example, add recipient page 440 (shown in FIG. 15). Shipping addresses and category names are stored in customer address database (not shown in FIG. 17) which is a portion of database 36 (shown in FIG. 1).

FIG. 18A is a flowchart 560 which diagrams procedures executed by and implemented in central computer system 502 of system 500 (shown in FIG. 16) to obtain private and secure shipping of goods using the Internet for registered users. User registration is described above in FIGS. 2B and 17. If registered, the user establishes 562 a secure connection to the private and secure purchasing and shipping provider web site, and activates 564 their account for private and secure shipping, which includes accessing a customer address database 566.

Once a user account is activated 564, the user's current list of delivery categories (aliases) is displayed 568, and the user selects one of those categories for the shipping of a package, for example, selection of a private recipient, as shown on pre-authorization transaction page 360 (shown in FIG. 9). After selection of a delivery category from database 566 (described in further detail in FIG. 18B below), the user is issued 570 a private and secure temporary shipping address code which is linked to the user's selected delivery category. The address code represents the final destination of the package (described in further detail in FIG. 18C below), and the user's temporary card numbers being used for purchases. After private and secure temporary shipping address codes are issued 570, the user's packages are shipped 572 to the temporary shipping address embedded within the address code, at least initially. If the shipping carrier is partnered with the private and secure shipping provider, the carrier receives 574 the packages and queries the private and secure shipping provider database to determine the final destination of the package, and the package is re-routed to the final destination, and delivered.

FIG. 18B is a flowchart 600 illustrating private shipping of goods using the Internet. A user which has successfully entered the private and secure purchasing provider system by entering a valid member number and user ID/password (described above), activates 564 (shown in FIG. 18A) private shipping of packages. The user then confirms 602 the default private shipping category or selects an alternate category from the previously stored other optional shipping addresses, for example, selection of a private recipient, as shown on pre-authorization transaction page 360 (shown in FIG. 9), also referred to herein as aliases. The private shipping module 506 (shown in FIG. 16) is then activated 604. Notification of the activation is sent to account cross referencing module 32 (also shown in FIGS. 1 and 16). Further, customer shipping information is sent to account cross referencing module 32 from customer database 606 within database 36 (shown in FIGS. 1 and 16). Also sent to account cross referencing module 32 is a temporary shipping address code, linked to the user's account, and used for determination of shipping information for the packages. The temporary shipping address code is generated based on information within address code database 608 and customer history database 610, both within database 36. Temporary address code module 508 (also shown in FIG. 16) determines 612 a least actively used temporary shipping address code within database 608 and determines 614 if the address code is currently active. In one embodiment, temporary shipping address codes are random reference number and letters. If active, module 508 determines 612 another address code that has been inactive the longest amount of time. The process is repeated until a temporary shipping address code that is currently inactive is identified. Once an inactive temporary shipping address code is determined 612, module 508 determines 616 if the particular address code has ever been assigned to that user previously for a shipment of goods. If so, the process above is repeated until an inactive temporary shipping address code that has never been assigned to the particular user is identified. The temporary shipping address code is then sent to account cross referencing module 32, which sets 618 the temporary shipping address code active by linking the temporary card numbers used to make a purchase to the temporary shipping address code used for the shipping of the purchase.

Private shipping is now completely activated 620 with a temporary shipping address code, defining a user selected shipping destination, further linked to the user account. A scheduler is then set 622 to deactivate the temporary shipping address code, once a pre-defined time limit has expired for delivery of the package. User account information, for example, the selected shipping category and temporary shipping address code, is placed 624 on user computer 40 (shown in FIGS. 1 and 16) in the form of an identification output file, from central computer system 502 (shown in FIG. 16).

FIG. 18C is a flowchart 640 illustrating using 642 the temporary address codes for private and secure shipping of Internet purchases. Referring specifically to flowchart 640, the user connects 644 to merchant computer 44 (shown in FIGS. 1 and 16) to shop and make selections for purchase via the Internet. After making their selections, the user selects 646 a delivery method, depending on whether the merchant is partnered with the private and secure shipping provider. If so partnered, the virtual store displays 648 a logo of the private and secure shipping provider. The user then uses 650 a member merchant's virtual shopping cart application to select goods and services. When ready to “check out” the user selects 652 the logo of the private and secure shipping provider as part of the checkout process. Information from the identification output file is then uploaded 654 from user computer 40 (shown in FIGS. 1 and 16) to merchant computer 44. A product pop-up window is displayed 656 which includes a user's selected category name for confirmation. After confirmation, the user's purchases are shipped 658 using a preferred carrier to the temporary shipping address. After the carrier has received the package, the carrier queries 660 the on-line temporary address code database, for example, via the Internet to access central computer 502, to determine a final destination of the package. The carrier then delivers the package to the user, or the user's designee (e.g. a purchase of a gift for a third party).

If the merchant is not partnered with the private and secure shipping provider, the user uses 664 the non-member merchant's virtual shopping cart application to select goods and services. When ready to “check out” the user enters 666 their private and secure shipping provider temporary shipping address code into the address information area on the merchant's payment and shipping form and submits the transaction. The non-member merchant treats the temporary shipping address code as a normal address and ships 668 the purchase to the user using the merchant's own or the user's own preferred delivery carrier.

The shipping carrier receives the package and queries 670 the on-line temporary address code database, as described above, to determine a final destination of the package, and delivers the package to the user, or the user's designee (e.g. a purchase of a gift for a third party).

While the invention has been described in terms of various specific embodiments, those skilled in the art will recognize that the invention can be practiced with modification within the spirit and scope of the claims.

What is claimed is:

1. A method for facilitating private and secure shipping of packages using the Internet, said method comprising:
accessing a secure shipping system account;
activating the account for shipping;
setting a package delivery time limit;
receiving temporary address codes that are assigned to the account; and
using the temporary address codes to direct the shipping of the packages.

2. A method according to claim 1 wherein accessing a secure shipping system account further comprises establishing a secure connection to a private and secure shipping provider web site.

3. A method according to claim 1 wherein activating the account for shipping further comprises:
entering a valid member number;
entering a valid user ID and password;
selecting a category name defining a shipping address for the packages; and
receiving user account information.

4. A method according to claim 3 wherein selecting a category name comprises selecting a default category name which defines a default shipping address for a user, while not providing the address of the recipient to the sender of the package.

5. A method according to claim 1 wherein using the temporary address codes to direct the shipping of the packages further comprises:
connecting to a merchant web site;
selecting at least one item for purchase and shipment;
selecting a private and secure shipping provider logo from a partnered merchant web site;
confirming selected shipping information, which is linked to the temporary address code; and
receiving the package from a carrier.

6. A method according to claim 1 wherein using the temporary address codes to direct the shipping of the packages further comprises:
connecting to a merchant web site;
selecting at least one item for purchase and shipment;
entering the temporary address code as the shipping address on the merchant payment and shipping form; and
receiving the package from a carrier.

7. A system configured to facilitate private and secure shipping for a user via the Internet comprising:
a central computer comprising:
a private shipping module;
a mail and shipping carrier database module; and
a temporary address codes module;
at least one Internet server coupled to said central computer; and
at least one of an Internet and an intranet server coupled to said central computer, and further coupled to a computer for a mail/shipping carrier, said central computer configured to assign temporary shipping address codes using said temporary address codes module, to an account of a registered user, the temporary shipping address codes sent by said system to a merchant, via the Internet, as shipping instructions for the package or packages.

8. A system according to claim 7 wherein said temporary address codes module is configured to:
access an address code database to select at least one inactive temporary shipping address code; and
access a customer history database to determine which temporary shipping address codes to allocate for a shipping.

9. A system according to claim 8 wherein to access a customer history database to determine which temporary shipping address codes to allocate said temporary address code module configures said central computer to:
select a least actively used temporary shipping address code;
determine if the selected temporary shipping address code is currently active for any other users; and
determine if the selected temporary shipping address code has been previously assigned to the user.

10. A system according to claim 7 wherein said central computer is configured with a scheduler to deactivate temporary shipping address codes once a package delivery time limit has expired.

11. A system according to claim 7 wherein said mail and shipping carrier database module is configured to identify shipping carriers which are partnered with the private and secure shipping provider.

12. A system according to claim 7 wherein said central computer further comprises a user identification module configured with at least one of member numbers, user IDs and passwords for registered users.

13. A system according to claim 7 wherein said central computer is configured to transmit a final destination to a mail/shipping carrier computer from said temporary address code module upon receipt of a query from the carrier computer.

14. A system according to claim 7 wherein said central computer further comprises an account cross-referencing module configured to:
retrieve user account information and category names from a customer database;
link the temporary shipping address codes received from said temporary address code module to user accounts; and
activate the user account for private shipping.

15. A system according to claim 7 wherein said central computer system is configured to transmit an identification output file to a user computer, the output file comprising user account information, temporary shipping address codes, and final destination information associated with the address codes.

16. A system according to claim 7 wherein said central computer is configured with shipping histories for each user.

17. A method for operating a computer to facilitate private and secure shipping, said method comprising:
prompting a user to enter a user ID and a password;
prompting the user to activate private shipping;
retrieving user account information; and
generating at least one temporary shipping address code for use by the user for shipping one or more packages.

18. A method according to claim 17 wherein generating at least one temporary address code further comprises prompting the user to select one of a default shipping category name or an alternate shipping category name.

19. A method according to claim 17 further comprising transmitting instructions to activate the temporary shipping address codes.

20. A method according to claim 17 further comprising transmitting an identification output file to a user computer, the output file comprising at least one of user account information, a temporary shipping address code, and destination information.

21. A method according to claim 17 wherein the temporary shipping address code is used to identify the recipient.

22. A method according to claim 17 further comprising transmitting at least one temporary shipping address code to an external computer to direct shipping of a package.

23. A method according to claim 22 wherein to direct shipping of a package, the external computer accesses a database to match the temporary shipping address code with a final destination for the package.

24. A database comprising:
data corresponding to merchants who are partnered with a private and secure shipping system provider;
data corresponding to temporary address codes;
data corresponding to user accounts;
data corresponding to customer histories; and
data corresponding to user IDs and passwords.

25. A database according to claim 24 where said data corresponding to customer histories comprises data corresponding to temporary shipping address codes previously assigned to a user for shipping packages.

26. A database according to claim 24 wherein said data corresponding to user accounts further comprises data corresponding to at least one of a default shipping category name and alternate shipping category names for a user.

27. A database according to claim 26 wherein said default shipping category name and said alternate shipping category names are configured to identify final shipping destinations.

28. A system to facilitate secure purchasing and shipping via the Internet comprising:
a central computer further comprising:
a digital checkbook module;
a merchant database module;
a temporary card number module;
a private shipping module;
a mail and shipping carrier database module; and
a temporary address codes module;
at least one Internet server coupled to said central computer; and
at least one of an Internet and an intranet server coupled to said central computer, and further coupled to an acquiring bank processor and a computer for a mail/shipping carrier,
said central computer configured to assign temporary debit and credit card numbers using said temporary card number module, to a checkbook of a registered user, the checkbook located within said digital checkbook module, the temporary card numbers being sent by said system to a merchant, via the Internet, to pay for purchases made by the registered user when accessing a merchant website,
said central computer further configured to assign temporary shipping address codes using said temporary address codes module, to an account of a registered user, the temporary address codes being sent by said system to at least one of the carrier computer and the merchant, via the Internet, as shipping instructions for the package or packages.

29. A system according to claim 28 wherein said temporary card number module is configured to:
access a card number database to select at least one inactive credit card number and at least one debit card number; and
access a customer history database to determine which card numbers to allocate for a session.

30. A system according to claim 29 wherein to access a customer history database to determine which card numbers to allocate said temporary card number module configures said central computer to:
select a least actively used credit card number and debit card number;
determine if the selected card numbers are currently active for any other users; and
determine if the selected card numbers have been previously assigned to the user.

31. A system according to claim 30 wherein said central computer is configured to deactivate debit and credit card numbers as soon as a time limit on a purchasing session has expired.

32. A system according to claim 28 wherein said central computer further comprises a merchant database and pricing module configured to identify merchants which are partnered with the private and secure purchasing provider.

33. A system according to claim 32 wherein said central computer system is configured to:
charge debit card rates for transactions to merchants who are partnered with the private and secure purchasing provider; and
charge credit card rates for transactions to merchants who are not partnered with the private and secure purchasing provider.

34. A system according to claim 28 wherein said central computer further comprises a user identification module configured with at least one of member numbers, user IDs and passwords, and recipient information for registered users.

35. A system according to claim 34 wherein said central computer is configured to assign member numbers to users who register for an account and provide finding for an account.

36. A system according to claim 28 wherein said central computer further comprises an account cross-referencing module configured to:
retrieve user account information and account balances from a customer database;
link the temporary card numbers received from said temporary card number module to user accounts; and
activate the card numbers.

37. A system according to claim 36 wherein to activate the card numbers, said central computer system is configured to send instructions to activate the card numbers to the acquiring bank processor.

38. A system according to claim 36 wherein said central computer system is configured to transmit an identification output file to a user computer, the output file comprising user account information, temporary card numbers, temporary shipping address codes, and final destination information.

39. A system according to claim 28 wherein said central computer further comprises an omnibus accounting module configured to access a customer database to retrieve user account balances and transaction histories.

40. A system according to claim 28 wherein said central computer is configured to allow a user who is registering with the private and secure purchasing provider to select an account funding option.

41. A system according to claim 28 wherein said central computer is configured to facilitate returns of Internet purchases.

42. A system according to claim 28 wherein said central computer is configured with a search page, which is configured to search one or more of selected Internet search engines and Internet directories to search for goods and services, based upon a single user entered search item.

43. A system according to claim 42 wherein said central computer is configured to display search results for all selected search engines and Internet directories in a single page, a frame being displayed within the page with search results for each of the selected search engines and Internet directories.

44. A system according to claim 28 wherein said central computer is configured with at least one of transaction histories and shipping histories for each user.

45. A system according to claim 28 wherein said central computer is configured with a help screen, said help screen including headings for at least one of logging in, logging off, activating checkbook, transaction history, privacy options, shopping search and returns, the headings configured as hyperlinks out of said help screen.

46. A system according to claim 28 wherein said temporary address codes module is configured to:
access a temporary shipping address code database to select at least one inactive temporary shipping address code; and
access a customer history database to determine which temporary shipping address codes to allocate for a shipping.

47. A system according to claim 46 wherein to access a customer history database to determine which temporary shipping address codes to allocate, said temporary address code module configures said central computer to:
select a least actively used temporary shipping address code;
determine if the selected temporary shipping address code is currently active for any other users; and
determine if the selected temporary shipping address code has been previously assigned to the user.

48. A system according to claim 28 wherein said central computer is configured with a scheduler to deactivate temporary shipping address codes once a pre-determined package delivery time limit has expired.

49. A system according to claim 28 wherein said mail and shipping carrier database module is configured to identify shipping carriers which are partnered with the private and secure shipping provider.

50. A system according to claim 28 wherein said central computer further comprises an account cross-referencing module configured to:
retrieve user account information and shipping categories from a customer database;
link the temporary shipping address codes received from said temporary address code module to user accounts; and
activate the user account for private shipping.

51. A computer programmed to:
couple to a user computer via at least one of an intranet and the Internet;
verify user entered member numbers and user IDs and passwords against an IDs and passwords database in a security module;
verify user account balances;
assign at least one temporary debit card number and at least one temporary credit card number to a user account for a purchasing session;
assign at least one temporary shipping address code to the user account for a purchasing session;
activate a user account, including card numbers and temporary shipping address codes for purchasing and shipping, respectively; and
transmit an identification output file to the user computer, the output file comprising user account information, card number information, and the temporary shipping address code.

52. A computer according to claim 51 wherein to assign at least one temporary shipping address code to the user account, said computer is further programmed to allow a user to select a category name from a list of category names.

53. A computer according to claim 52 wherein a category name includes an alias and a final destination for the alias.

54. A computer according to claim 51 wherein to assign temporary card numbers, said computer is programmed to:
access a database of inactive card numbers;
select a least actively used credit card number and debit card number;
determine if the selected card numbers are currently active for any other users; and
determine if the selected numbers have been previously assigned to the user using a customer history database.

55. A computer according to claim 51 wherein to assign temporary shipping address codes, said computer is programmed to:
access a database of inactive temporary shipping address codes;
select a least actively used temporary shipping address code;
determine if the selected temporary shipping address code is currently active for any other users; and
determine if the selected temporary shipping address code has been previously assigned to the user using a customer history database.

56. A computer according to claim 55 programmed to provide final destination information for a package upon receipt of a query from a mail/shipping carrier computer.

57. A computer according to claim 51 wherein to activate a user account for purchasing, said computer is programmed to transmit instructions to an acquiring bank processor to activate the card numbers.

58. A computer according to claim 51 wherein to activate a user account, said computer is programmed to deactivate temporary shipping address codes after a time sufficient for receipt of any shipped packages has passed.

59. A method for facilitating private and secure purchasing and shipping of purchased items using the Internet, said method comprising:
accessing a secure purchasing and shipping system account;
funding the account;
activating the account for purchasing and shipping;
receiving temporary card numbers and expiration dates for the numbers that are assigned to the account;
receiving temporary address codes that are assigned to the account;
using the temporary card numbers to purchase items over the Internet; and
using the temporary address codes to direct the shipping of the purchased items.

60. A method according to claim 59 further comprising setting at least one of a transaction amount limit, a time limit for a purchasing session, and a package delivery time limit using the account.
